(19) United States
(12) Patent Application Publication
(10) Pub. No.: US 2025/0389579 A1
(43) Pub. Date: Dec. 25, 2025

(54) Shaded-Truss Externally Occulted Solar Coronagraph

(71) Applicant: Southwest Research Institute, San Antonio, TX (US)

(72) Inventors: Craig DeForest, Nederland, CO (US); Daniel B. Seaton, Boulder, CO (US); Amir Caspi, Boulder, CO (US)

(21) Appl. No.: 18/754,012

(22) Filed: Jun. 25, 2024

(51) Int. Cl. G01J 1/04; G01J 1/06; G02B 23/24

(52) U.S. Cl. CPC G01J 1/0403; G01J 1/0437; G02B 23/2476; G01J 2001/061

(57) ABSTRACT

An occulting assembly for use with a telescope or other imaging instrument when viewing the sun or other bright light source. An occulting disk is supported by a set of thin stiff truss rods. These truss rods are attached to the dark side of the adapter at one end and to an adapter at the other end. The adapter provides a mechanical interface to the telescope or other imaging instrument and has an aperture piece that defines an aperture in its center. The occulting disk is sized to completely shadow the aperture and the truss is arranged so that it is within the shadow of the occulting disk.

### FEDERALLY SPONSORED RESEARCH AND DEVELOPMENT

This invention was made with United States Government Support under Grant ID #2231658 and #2308305 from the National Science Foundation. The Government has certain rights in this invention.

### BACKGROUND OF THE INVENTION

The solar corona is an important subject of study for both scientific and practical reasons. Present in the sky at all times when the Sun is up, the corona surrounds the Sun and is roughly as bright as the full Moon. It is ever changing with different appearance day-to-day and important changes that occur as rapidly as seconds to minutes.

Viewing the corona is difficult because of the photometric contrast between the Sun itself (the solar photosphere) and the corona. Near the visible limb of the Sun, the contrast is roughly a factor of one hundred thousand (100,000). One degree of angle from the apparent center of the Sun, the contrast is more than a billion (1,000,000,000). To photograph the corona, it is therefore necessary to remove the bright rays of the solar photosphere from the instrument. This is typically accomplished with a “coronagraph”, that is, an optical imaging device that has an occulting system to control stray light.

Occulting systems can be either internal or external. The first coronagraphs used a low-scatter first lens and an internal device (“internal occulter”) to eliminate light rays in a real image of the Sun, before re-imaging the remaining rays from the surrounding corona. This method selects the rays very precisely, at the cost of imposing stray light from scatter at the initial lens. More recent designs can include an external occulter. This is an engineered opaque object that is supported in front of aperture of the main imaging instrument, which is typically a telescope and is referred to herein as such and understood to include other imagers. The external occulter blocks direct rays of the Sun from contacting any portion of the telescope.

Externally occulted coronagraphs offer better stray light control than internally occulted coronagraphs but suffer from design constraints that prevent full exploitation of occulting physics. Occulter quality is determined in part by the physics of Fresnel diffraction, which require a large occulter as far as possible from the telescope's aperture; the ideal occulter is infinitely large and infinitely far away compared to the size scale of the telescope, which is why natural solar eclipses are sought after for their rare glimpses of an ideally occulted solar corona, using the Moon as a very large and very distant occulter.

However, in general, externally occulted coronagraphs must support the occulter, and in conventional designs, this requires a large leading baffle structure. Conventional designs have a fully enclosed, dark, rigid “vestibule” in front of the leading optics, to support the occulter and control stray light. The vestibule is a significant structure that drives mass, alignment characteristics, and cost of deployed instruments. This limits the available field of view of extremely wide-field coronagraphs with fields of view extending beyond 3-5 degrees, and also imposes a minimum stray light level from Fresnel diffraction by limiting the important occulter-optics distance.

### BRIEF DESCRIPTION OF DRAWINGS

FIG. 1 is a perspective view of the occulter assembly mounted on a telescope.

FIG. 2 illustrates the occulter assembly in further detail.

FIG. 3 illustrates the basic geometry of the occulting assembly used to specify the occulting disk.

FIG. 4 illustrates the aperture piece, viewed from the point of view of the occulting disk.

FIG. 5 is a perspective view of the aperture piece mounted to the front plate.

FIG. 6 illustrates the front plate.

FIG. 7 illustrates the telescope tube extension.

FIG. 8 illustrates one embodiment of the occulting piece.

### DETAILED DESCRIPTION OF THE INVENTION

The following description is directed to an externally occulted solar coronagraph, more specifically described as a front-end external occulter-and-aperture assembly (referred to herein as an “occulter assembly”). The occulter assembly may mount directly to a telescope. It enables direct optical viewing of the solar corona, and provides improved stray light rejection, lower mass, and wider field of view as compared to other coronagraphs. It may be assembled from readily available hardware and FDM (Fusion Deposition Modeling) equipment or from other more conventional materials such as machined metal. While the occulter assembly is specifically designed for solar applications it is also suitable for viewing faint objects near extremely bright and resolved light sources other than the Sun.

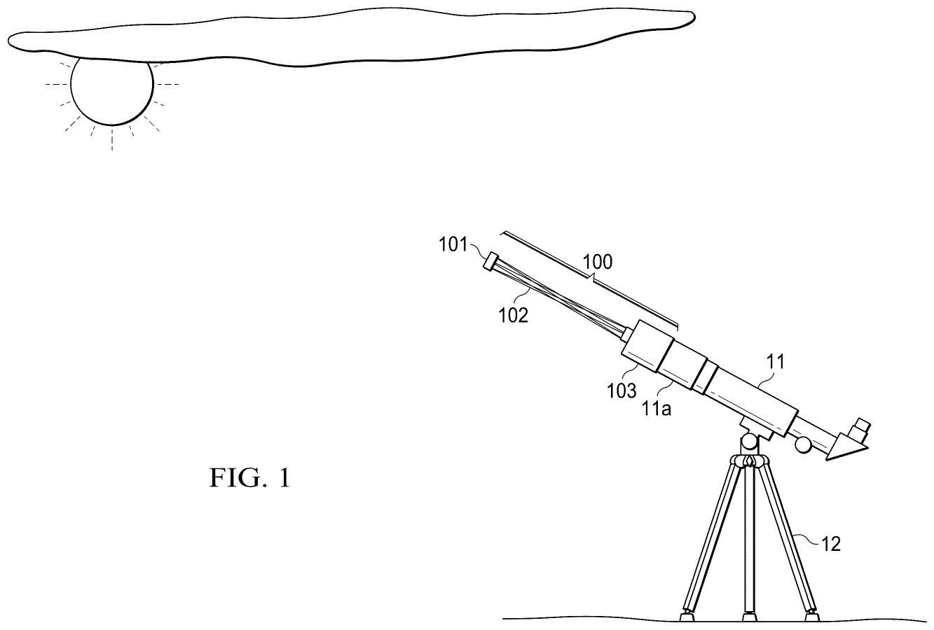

FIG. 1 is a perspective view of the occulter assembly 100. Assembly 100 is suited for placement over the viewing tube of an imaging instrument, such as a telescope 11 mounted on a tripod 12. For solar occulting, occulter assembly 100 is shown as being positioned (aimed at the sun) so that the sun is properly occulted. The use of occulter assembly 100 with a telescope and tripod is an example of one application; occulter assembly 100 could be deployed in other systems including but not limited to observatories, scientific balloons, spacecraft, or other types of imaging systems.

Various means may be used to attach occulter assembly 100 to the telescope 10. In FIG. 1, occulter assembly 100 has been slipped over a telescope tube 11a that covers the lens of a commercial telescope. An example of a suitable telescope is one having an 80-millimeter diameter aperture that is a tube-based dioptric telescope.

Occulter system 100 has an occulting disk 101, a truss 102, and an adapter 103. Occulting “disk” 101 is referred to as such because its shape is generally disk-like. As used herein, “disk” is meant to include various shapes more complex than a single disk. It may have various designs, which may be single disk or multi-disk assemblies so that multiple Fresnel scattering events are required for light to enter the instrument aperture. In general, multi-disk occulters have more gently curved envelopes than a similarly sized sphere.

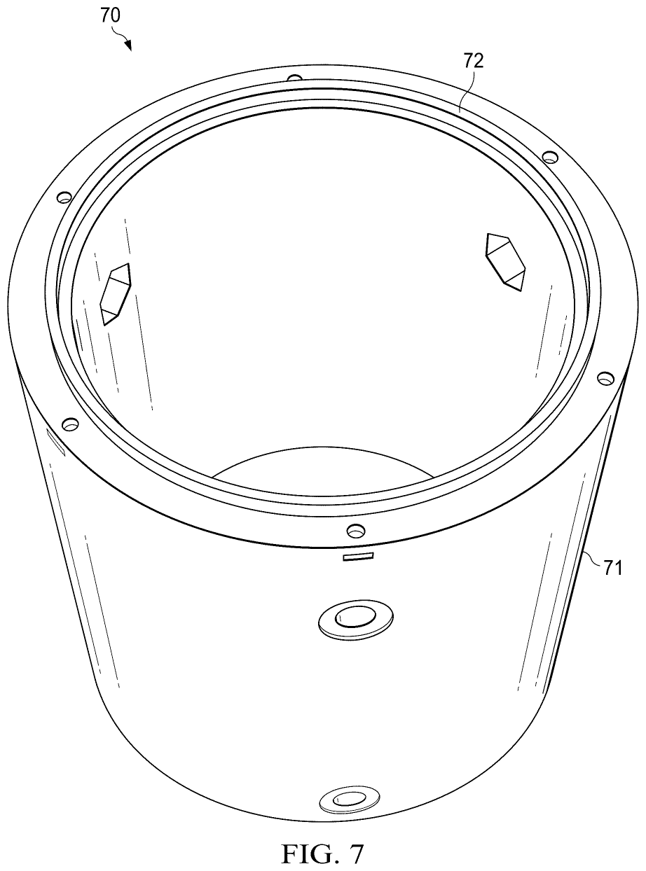

As described below in connection with FIG. 7, in one embodiment, occulting disk 101 is an FDM-fabricated plastic element with a “puck” shape, especially designed with an approximate ogive shape with sufficiently long major diameter to allow multiple FDM ridges to interact with the light, thereby approximating the effect of a series of very finely machined disks in a more conventional occulter.

The ideal envelope is close to an “ogive”: a figure of revolution of a large circle, about a chord near the perimeter of the circle. The ogive may be truncated outside the relevant portion of the surface that defines the occulted field of view. An ogive shape allows a constant angular offset between uniformly spaced disks. An ogive form may be approximated with a prolate circular ellipsoid, especially if it is truncated near the widest portion of the ellipsoid.

Truss 102 extends from adapter 103 forward to support occulting disk 101 in a manner such that the mechanical support for occulting disk 101 is entirely contained within the umbral shadow of the occulting disk 101. This results in a “shaded” truss 102, which greatly reduces stray light from the occulter support as well as eliminates a need for an enclosing baffle system. The specific structure of the truss (hexapod or other) may vary provided that it is sufficiently sparse to allow the aperture a clear, albeit slightly vignetted, view to the side of the Sun.

This shaded-truss design improves upon conventional vestibule-and-pylon occulter designs by separating the functions of optical baffling from mechanical support of the occulter. More specifically, occulting assembly 100 separates the functions of limiting field of regard (the optical purpose of a vestibule in conventional coronagraph designs) and supporting an external occulter (the mechanical purpose of the vestibule in conventional designs). This allows better optimization of each of those two functions. First, by supporting the occulting disk with minimal bulk and mass, the shaded-truss design enables greater separation between the occulter and aperture than conventional designs, significantly reducing Fresnel diffraction for designs of comparable feasibility. Second, by containing all mechanical support inside the umbral shadow of the occulting disk 101, the shaded-truss design eliminates glint and other forms of stray light from an occulter support pylon and its support structure, a major concern with conventional designs.

Adapter 103 provides support for truss 102, as well as to define an aperture consistent with the design of occulting disk 102. It also provides an optically appropriate attachment and interface to telescope 11 so that the desired corona imaging can occur. The specific form of adapter 103 is dependent on the nature of the imaging instrument behind occulter assembly 100, with adapter 103 being an example suited to the telescope application of FIG. 1.

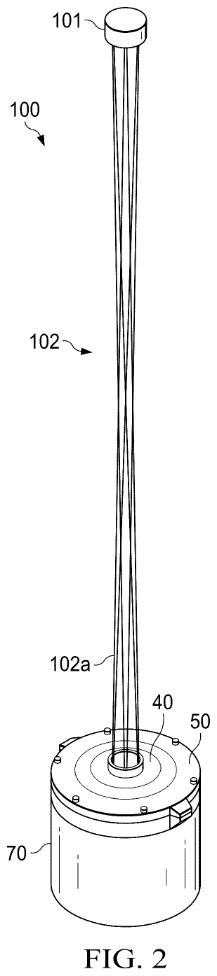

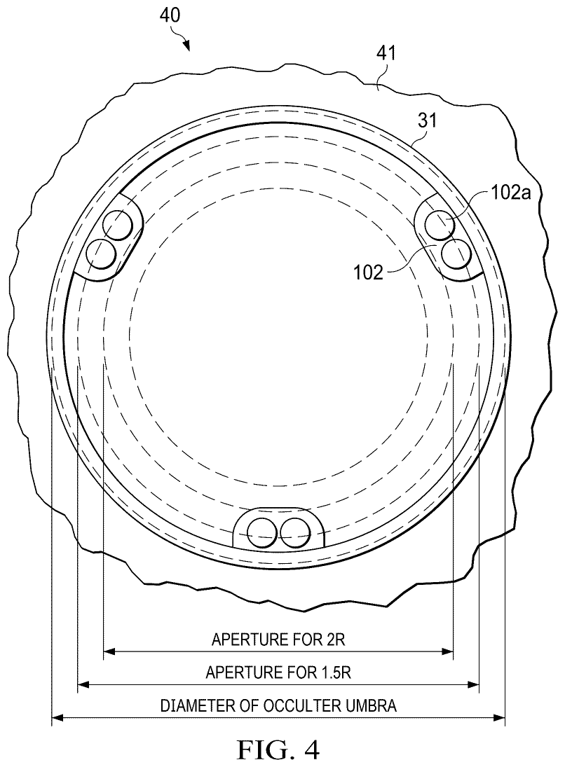

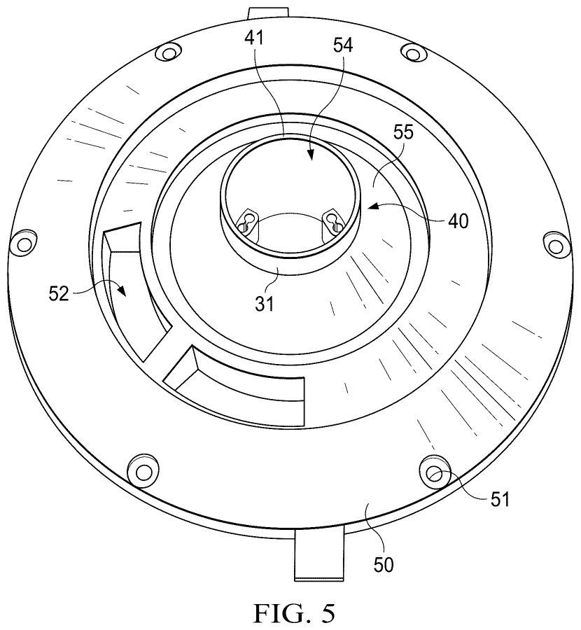

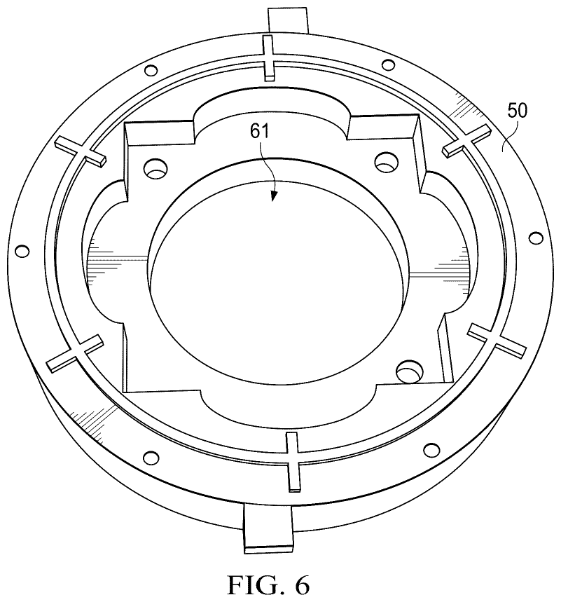

FIG. 2 illustrates occulter assembly 100 in further detail. In this embodiment, adapter 103 has three parts: an aperture piece 40 (see FIGS. 4 and 5), a front plate 50 (see FIG. 6), and a telescope tube extension 70 (see FIG. 7). These parts are connected together to form adapter 103, with the aperture piece 40 being closest to occulting disk 101, then the front plate 50, then the tube extension 70. They have been designed for convenient manufacture with FDM methods. However, adapter 103 may be implemented with more or fewer discrete parts, provided its basic structure and functions described herein are fulfilled.

Occulting disk 101 is attached to aperture piece 40 by means of truss 102. In the example of this description, truss 102 comprises six thin stiff rods 102a in a hexapod configuration around an aperture in the center of aperture piece 20. An example of a suitable material for rods 102a is carbon fiber. Rods 102a are attached to aperture piece 40 near the periphery of the umbral shadow of occulting disk 101, but fully contained within it and support the occulting disk 101 while reducing optical vignetting of the instrument's field of view.

As explained below, other truss configurations are possible, with a common feature being that truss 102 is wholly contained within the umbral shadow of occulting disk 101 when occulter assembly 100 is in use. In other embodiments, a truss having truss rods near the center of the umbra may support the occulting disk 101 while again reducing or eliminating external optical vignetting of the instrument field of view.

Truss 102 may be sufficiently long such that occulting disk 101 is supported well in front of the optical aperture. An example of a suitable length of truss rods 102a is 75 cm. The truss rods 102a are attached to the occulting disk 101 at their distal ends (relative to adapter 103) and to aperture piece 40 at their proximal ends. These attachments may be by various attachment means and by simply using glue.

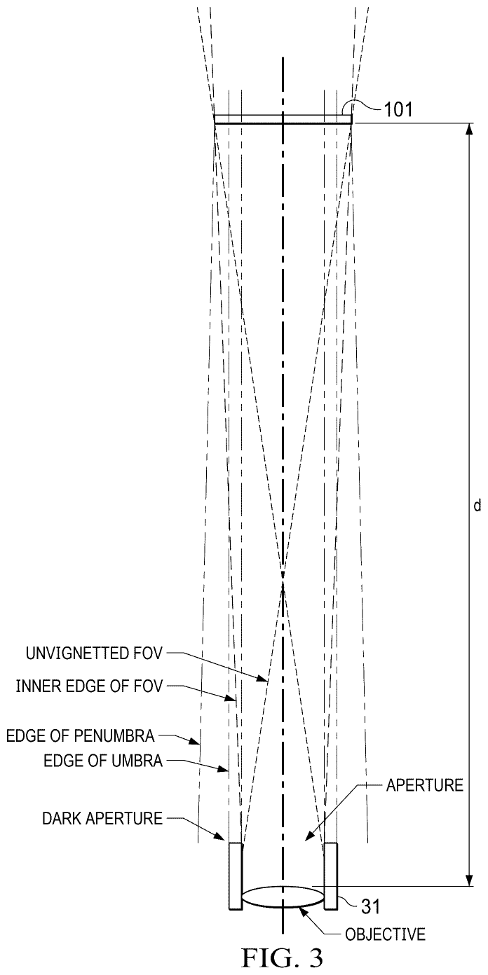

FIG. 3 illustrates the basic geometry of occulting assembly 100 used to specify occulting disk 101. Occulting disk 101 casts a shadow down the length of the occulting assembly 100. The occulting disk 101 is sized to completely shadow the aperture and the dark baffle area. Penumbral and umbral edges are formed by the outer edge of the occulter 101. The occulter 101 is sized such that the edge of the umbra lands outside a “dark aperture” that extends beyond the objective lens of the system. The optical field of regard is limited by a thin circular (corral) baffle 31.

The inner edge of the FOV (field-of-view) is set by the angle between the edge of the occulting disk 101 and the near edge of the aperture. The innermost unvignetted portion of the FOV is set by the angle between the edge of the occulting disk 101 and the farthest edge of the aperture. The umbra and penumbra extend inward and outward, respectively, from the edge of the occulting disk 101 as shown. The spreading angle between the umbral and penumbral boundaries is the apparent solar diameter and is exaggerated in FIG. 3 by a factor of 5.

Referring again to FIG. 2, the shaded-truss design of occulter system 100 supports the occulter 101 on truss 102, which is stiff enough to maintain occulter alignment, while remaining fully within the umbral shadow of the occulter 101 and also obscuring as little of the FOV as practical. In other words, truss 102 is directedly shaded by occulting disk 101, simplifying stray light control by keeping the support structure out of direct sunlight. As further explained below, the truss rods 102a may be arranged as a “hexapod truss” having equilateral triangles, with three triangles having an apex at occulting disk 101 and three triangles having an apex at the aperture piece 40, such that the apices at occulting disk 101 themselves form an equilateral triangle with two rod ends at each corner, and the apices at aperture piece 40 form a complementary equilateral triangle in the same manner.

The hexapod truss 102 described herein is a particular example, but other configurations are encompassed in the basic design, including solutions focused on a narrower support structure near the centerline of the instrument, or solutions using stiffener brackets along the length of the exterior rods. Truss rods 102a may be in the form of a hexapod or other appropriate figure. Such structures may require more mass to achieve the same stiffness as the hexapod truss but impose less vignetting on the final imaging properties. A common feature of the various embodiments of truss 102 is the use of stiff rods that are within the umbral shadow.

FIG. 4 illustrates aperture piece 40, viewed from the point of view of occulting disk 101. At its center is a primary aperture, sized to fit well inside the umbra of the occulting disk 101. The aperture lets light enter from around the occulting disk 101 to the iris and then through the adapter to the telescope. In other words, the occulting assembly 100 accepts light from a complete annulus of angles, to be imaged by the telescope.

To minimize the dark aperture region shown in FIG. 3, the aperture hole in aperture piece 40 is not a complete circle. The surrounding deck 41 supports three support mounts 42 for the shaded feet of truss 102, impinging on the circular aperture. This reduces the diameter of the required dark-shadow region by supporting truss rods 102a from inside the active aperture of the instrument. The ends of truss rods 102a may be placed into holes in the support mounts 42. As indicated, support mounts 42 can provide the triangular arrangement of the truss rods 102a described above, with pairs of rods having their ends mounted close together at one end of truss 102 and farther apart at the other. The support holes may be slightly canted, such as at an angle of 0.4 degrees, to avoid over constraint of the truss rods.

An optional optical-grade adjustable-iris aperture stop (not shown) may be located just behind the three truss support decks 42. It may be used to control the size of the optical aperture and thereby the inner limit of the annular field of view, further reducing stray light inside the instrument.

The aperture and truss decks 42 are surrounded by a thin circular baffle 31, which is just inside the umbra of the occulting disk and just outside the aperture-plane triangle formed by the truss rods 102a. The top few millimeters of baffle 31 are thinned, for example just 0.5 mm wide, to separate the umbra from penumbra while retaining as much open aperture as possible. In other words, the optical aperture of occulting assembly 100 is surrounded by a tall narrow corral baffle 31 that “slices” the outer portion of the occulter umbra from the penumbra and fully illuminated outer portion. This not only reduces stray light from sunlight surrounding the telescope, but also serves as a useful alignment fiducial. The penumbral shadow of the occulting disk 101, under ideal observing conditions, forms a symmetric “dark spot” concentric with the wall of the baffle 31, which may be observed directly in manually controlled ground-based applications or used as a mount point for pointing control sensors as described below.

FIG. 5 is a perspective view of aperture piece 40 mounted to front plate 50. Two of the truss decks 42 can be seen inside baffle 31 and at the base of the central aperture. In the embodiment of FIG. 5, aperture piece 40 has a conical support 55 for baffle 31, the conical support extending toward the occulting disk 101 and defining the primary aperture 54 at its top.

Aperture piece 40 is fixed precisely, relative to supporting front plate 50. Radially aligned rectangular alignment holes 51 may be used for this purpose. Aperture piece 40 may be secured by fasteners that extend, via through-holes that penetrate the aperture piece and front plate, into captive square nuts in supporting telescope tube 60.

Slot 52 in the aperture piece 40 may give access to an adjustment lever on an adjustable-iris aperture stop underneath, if needed for a particular embodiment. In that case, slot 52 acts as a light trap to avoid increasing stray light or glint.

FIG. 6 illustrates front plate 50, an interface upon which aperture piece 40 rests, and which accepts and supports an optional adjustable-iris aperture stop (not shown), and in turn rests on a telescope adapter tube 70. The aperture stop, if present, may be bolted in place with three through-bolts that mate with captive hex nuts on the underside of the front plate. In the example of this description, positional alignment is maintained between the mounted aperture piece 40 and the bolted-on aperture stop, via six extruded alignment features that mate with alignment holes on the underside of the aperture piece. In that example, a circular mounting ring, together with a corresponding groove on the underside of the aperture piece, forms a four-bounce “optical maze” to prevent stray light entering the dark space behind the aperture.

A central hole 61 in front plate 50 allows light to enter the telescope objective lens. In the example of this description, this hole is 55 mm diameter. A square recess accepts the optional adjustable-iris aperture stop (not shown).

FIG. 7 illustrates the telescope tube extension 70, a cylindrical piece that fits over the tube of a telescope 11. It may be secured to the telescope with bolts. A circular mount ring aligns the tube and prevents external light from entering. The front plate 50 and aperture piece 40 are secured to tube extension 70, such as by bolts into captive nuts.

Although not shown, occulting assembly 100 may be equipped with actively controlled positioners to align the occulting disk 101 after assembly without local human intervention. These positioners may include, for example, length adjusting devices for truss 102, or pointing actuation devices to aim the entire assembly. For an actively pointed instrument, the exterior of the corral baffle 31 is an ideal location to mount optical sensors and drive such a pointing system with direct active feedback.

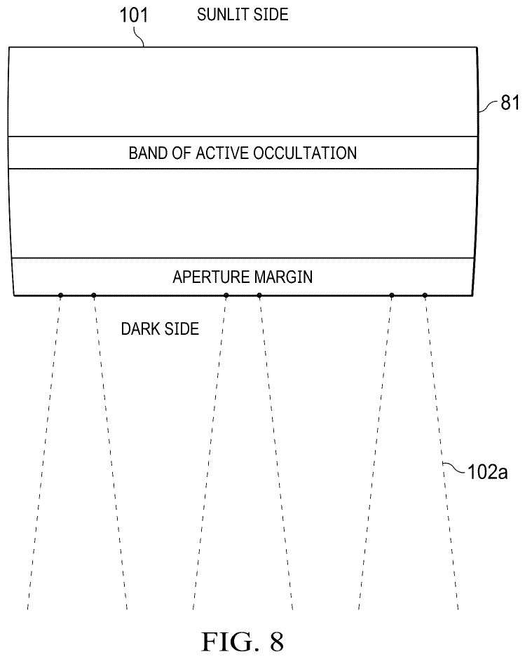

FIG. 8 illustrates one embodiment of occulting disk 101. Disk 101 has the truncated ellipsoid shape (approximate ogive) described above. FIG. 8 also illustrates how the attachment locations of truss rods 102a at the bottom of occulting disk 101 form the hexapod triangular support truss as described above.

Occulting disk 101 uses what is typically considered a flaw in fusion deposition modeling (FDM) 3D printing to advantage in this embodiment. FDM printing produces structures that are layered, with corrugated outer faces. For occulting disk 101, this results in corrugations 81 on the outer surface. These corrugations 81 are used as “mini-occulting-disks”, providing some of the benefits of a conventional machined-metal multi-disk occulter at lower cost. The height and depth of corrugations 81 may be tailored for specific needs.

The overall ogive envelope provides some independence of performance from mount alignment angle, by approximating a spherical occulter (which would perform equally at all angles and therefore does not require alignment) but stretching it along the instrument boresight to force diffracted light to interact with multiple corrugations along the side of the occulter. This provides a design with wide enough tolerances to be assembled with hand-tooling methods and a simple jig, but sufficient performance to reveal the corona at apparent distances up to 1.5-2 solar radii on the sky, after image post-processing.

1. An occulting assembly for use with a telescope or other imaging instrument when viewing the sun or other bright light source, comprising:
an occulting disk;
a set of truss rods, the truss rods being thin and stiff;
an adapter having at least a mechanical interface to the telescope or other imaging instrument and having an aperture piece that defines an aperture in its center;
wherein the truss rods form a truss that is attached to the bottom of the occulting disk and to the top of the adapter and have distal ends and proximal ends relative to the adapter;
wherein the occulting disk is sized to completely shadow the aperture; and
wherein proximal ends of the truss rods are attached to the adapter around the perimeter of the aperture and the distal ends of the truss rods are attached to the occulting disk, such that the truss is fully within the shadow of the occulting disk.

2. The occulting assembly of claim 1, wherein the occulting disk casts an umbral shadow and the truss rods are attached near the periphery of the umbral shadow.

3. The occulting assembly of claim 1, wherein occulting disk casts an umbral shadow and the truss rods are attached near the center of the umbral shadow.

4. The occulting assembly of claim 1, wherein the telescope is a dioptric tube telescope and the mechanical interface is a tube that slips over an objective end of the telescope.

5. The occulting assembly of claim 1, wherein the occulting disk comprises a single disk-shaped piece.

6. The occulting assembly of claim 1, wherein the occulting disk comprises multiple disk-shaped pieces.

7. The occulting assembly of claim 1, wherein the adapter slips over a telescope tube.

8. The occulting assembly of claim 1, wherein the occulting disk is puck-shaped.

9. The occulting assembly of claim 1, wherein the occulting disk has or approximates an ogive shape.

10. The occulting assembly of claim 1, wherein the occulting disk has a truncated ogive shape.

11. The occulting assembly of claim 1, wherein the set of truss rods comprises six truss rods in a hexapod configuration.

12. The occulting assembly of claim 1, wherein the truss rods form triangles as a result of their attachment to the occulting disk and the adapter.

13. The occulting assembly of claim 1 wherein the aperture piece has a baffle around the aperture and the truss rods are attached inside the baffle.
